(19) United States
(12) Patent Application Publication
(10) Pub. No.: US 2008/0022869 A1
(43) Pub. Date: Jan. 31, 2008

(54) APPARTUS AND METHOD FOR PRINTING SCREEN

(75) Inventor: Art Dobie, Mount Holly, NJ (US)

Correspondence Address: WALTER J. TENCZA JR., 100 Menlo Park, Suite 210, Edison, NJ, 08837, US

(73) Assignee: SEFAR PRINTING SOLUTIONS, INC., Lumberton, NJ (US)

(21) Appl. No.: 11/309,342

(22) Filed: Jul. 28, 2006

(51) Int. Cl. B41F 15/34

(52) U.S. Cl. 101/128.1; 101/129

(57) ABSTRACT

An apparatus is provided comprising a printing screen frame, a first sheet attached to the printing screen frame, an alignment frame, and an alignment device. The alignment device may have a first means for registering the printing screen frame and the first sheet in a first position and a first orientation, with respect to the alignment device, and a second means for registering a second sheet with respect to the alignment device. The first sheet may be a wire mesh. The second sheet may be a photo tool. In addition, first and second current devices can be attached to the printing screen frame to apply current to the frame and the first sheet.

### FIELD OF THE INVENTION

This invention relates to improved methods and apparatus concerning devices for printing screens.

### BACKGROUND OF THE INVENTION

There are various known devices for printing screens. Screen printing is performed by using a squeegee to push ink through the openings in tensioned screen mesh onto a desired object. In the prior art, the frame part of a printing screen assembly is typically a monolithic component, usually comprised of wood or various metals such as aluminum, magnesium or steel, as well as some structural plastic materials.

### SUMMARY OF THE INVENTION

One embodiment of the present invention includes an apparatus comprising a printing screen frame, which surrounds a first central opening. A first sheet is attached to the printing screen frame so that the first sheet covers the central opening. The apparatus may also include an alignment device having a second central opening. The alignment device may have a first means for registering the printing screen frame and the first sheet in a first position and a first orientation, with respect to the alignment device, such that the first central opening of the printing screen frame is substantially aligned with the second central opening of the alignment device.

The printing screen frame may have a first side, a second side, a third side, and a fourth side, which border the first central opening. The alignment device may have a first side, a second side, a third side, and a fourth side, which border the second central opening. The first and third sides of the printing screen frame may be substantially parallel, the second and fourth sides of the printing screen frame may be substantially parallel, and the first and fourth sides of the printing screen frame may be substantially perpendicular. The first and third sides of the alignment device may be substantially parallel, the second and fourth sides of the alignment device may be substantially parallel, and the first and fourth sides of the alignment device may be substantially perpendicular.

The printing screen frame may have a first set of openings, each of which passes through its first side. The first means for registering of the alignment device can be inserted into the first set of openings of the printing screen frame in order to register the printing screen frame and the first sheet in the first position and the first orientation. The printing screen frame may have a second set of openings each of which passes through its second side. The first means for registering of the alignment device can be inserted into the second set of openings of the printing screen frame in order to register the printing screen frame and the sheet in a second position and a second orientation.

A second sheet may also be provided having a plurality of openings. The alignment device may include a second means for registering. The second means for registering may be inserted through the plurality of openings of the second sheet in order to register the second sheet in a second position and a second orientation with respect to the printing screen frame and with respect to the alignment device. Typically, in the second position and in the second orientation, a central portion of the second sheet is located over the first sheet, over the first central opening of the printing screen frame, and over the second central opening of the alignment device.

The first sheet may be comprised of a wire mesh. The second sheet may be comprised of a photo tool.

In one embodiment of the present invention, an apparatus is provided including a printing screen frame as previously described, an alignment frame as previously described, and first and second current devices. The first and second current devices can be attached to first and second opposing ends, respectively, of the printing screen frame, after the printing screen frame has been inserted into the alignment frame, so that current can be applied to the printing screen frame and the first sheet through the first and second current devices. The alignment frame may include a magnetic device or devices for attracting and securing the printing screen frame to the alignment frame.

In one embodiment of the present invention a method is provided including attaching a first sheet to a printing screen frame so that the first sheet covers a first central opening of the printing screen frame. The method may also include aligning the first central opening of the printing screen frame with a second central opening of an alignment device, and registering the printing screen frame and the first sheet, in a first position and a first orientation with respect to the alignment device by using a first means for registering located on the alignment device.

In another embodiment a method is provided including inserting a printing screen frame into an alignment frame so that a first central opening of the printing screen frame is aligned with a second central opening of the alignment frame. The method further includes attaching first and second current devices onto first and second opposing ends, respectively, of the printing screen frame, after the printing screen frame has been inserted into the alignment frame. The method also includes applying current to the printing screen frame and the first sheet through the first and second current devices. The method may further include incorporating a magnetic device or devices into the alignment frame so that the magnetic device can attract and secure the printing screen frame to the alignment frame.

### BRIEF DESCRIPTION OF THE DRAWINGS

FIG. 1 shows a top view of a printing screen frame in accordance with an embodiment of the present invention;

FIG. 2 shows a bottom view of an alignment frame in accordance with an embodiment of the present invention;

FIG. 3 shows a top view of the alignment frame of FIG. 2;

FIG. 4 shows a front view of the alignment frame of FIG. 2;

FIG. 5 shows a left side view of the alignment frame of FIG. 2;

FIG. 6 shows a top view of an alignment device in accordance with an embodiment of the present invention;

FIG. 7A shows a top view of a quick connect current clip in accordance with an embodiment of the present invention;

FIG. 7B shows a bottom view of the quick connect current clip of FIG. 7A;

FIG. 8A shows a left side view of the quick connect current clip of FIG. 7A;

FIG. 8B shows a right side view of the quick connect current clip of FIG. 7A;

FIG. 9A shows a front view of the quick connect current clip of FIG. 7A;

FIG. 9B shows a rear view of the quick connect current clip of FIG. 7A;

FIG. 10 shows a bottom view of the printing screen frame of FIG. 1 inserted into the alignment frame of FIG. 2;

FIG. 11 shows a top view of a pre-punched substantially transparent sheet having a pattern thereon;

FIG. 12 shows a top view of the printing screen frame of FIG. 1 with a translucent sheet attached to the printing screen frame;

FIG. 13 shows a bottom view of the printing screen frame of FIG. 1 with the translucent sheet attached to the printing screen frame;

FIG. 14 shows a bottom view of the printing screen frame of FIG. 1 with the translucent sheet attached to the printing screen frame attached to the alignment device of FIG. 6;

FIG. 15 shows a bottom view of the printing screen frame of FIG. 1 with the translucent sheet attached to the printing screen frame attached to the alignment device of FIG. 6, and with the pre-punched substantially transparent sheet of FIG. 11 attached to the alignment device of FIG. 6; and

FIG. 16 shows a bottom view of the printing screen frame with attached translucent sheet of FIG. 12 inserted into the alignment frame of FIG. 2, and with two quick connect current clips attached to the sides of the printing screen frame.

### DETAILED DESCRIPTION OF THE DRAWINGS

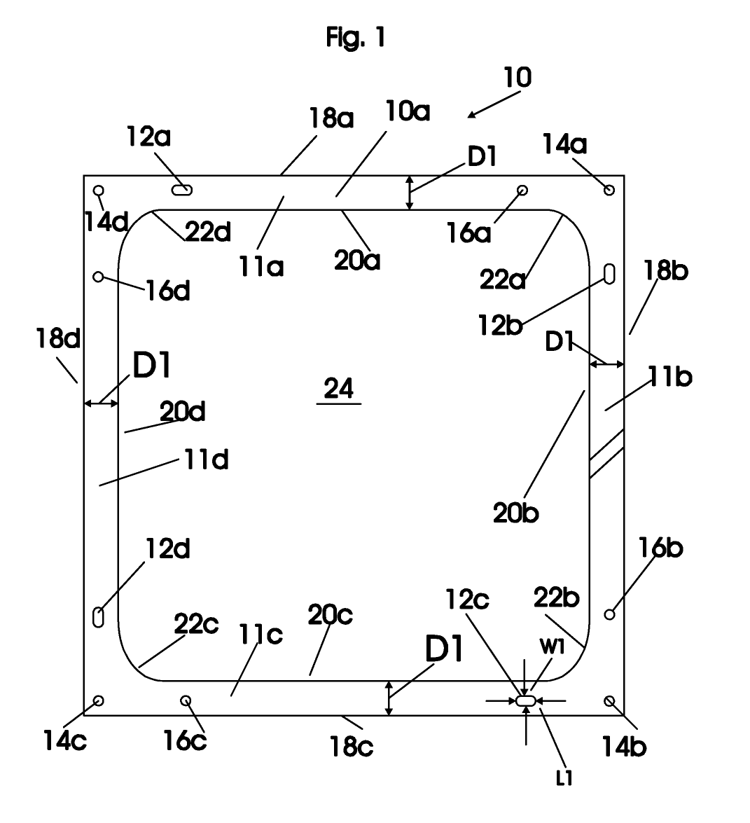

FIG. 1 shows a top view of a printing screen frame 10 in accordance with an embodiment of the present invention. The printing screen frame 10 is substantially a metal plate having a plurality of openings. The printing screen frame 10 surrounds a large central opening 24. The printing screen frame 10 also has openings 14a, 14b, 14c, 14d, 16a, 16b, 16c, and 16d, each of which may be approximately one quarter inch in diameter. The screen frame 10 also has openings 12a, 12b, 12c, and 12d each of which may be elongated with a length, L1, of one-half inch, and a width, W1, of one quarter inch. The printing screen frame 10 has outer edges 18a, 18b, 18c, and 18d and inner edges 20a, 20b, 20c, and 20d. The inner edge 20a is connected to inner edge 20b by curved edge 22a. The inner edge 20b is connected to inner edge 20c by curved edge 22b. The inner edge 20c is connected to inner edge 20d by curved edge 22c. The inner edge 20d is connected to inner edge 20a by curved edge 22d. The printing screen frame 10 can be described as being comprised of four members or four sides, such as horizontal members or sides 11a and 11c, and vertical members or sides 11b and 11d. Sides 11a and 11c are substantially parallel to each other, and substantially perpendicular to sides 11b and 11d. Sides 11b and 11d are substantially parallel to each other.

The distance D1, between the outer edges 18a-d and the inner edges 20a-d, respectively, as measured perpendicularly to the outer edges 18a-d and the inner edges 20a-d, respectively, may be seven eighths of an inch.

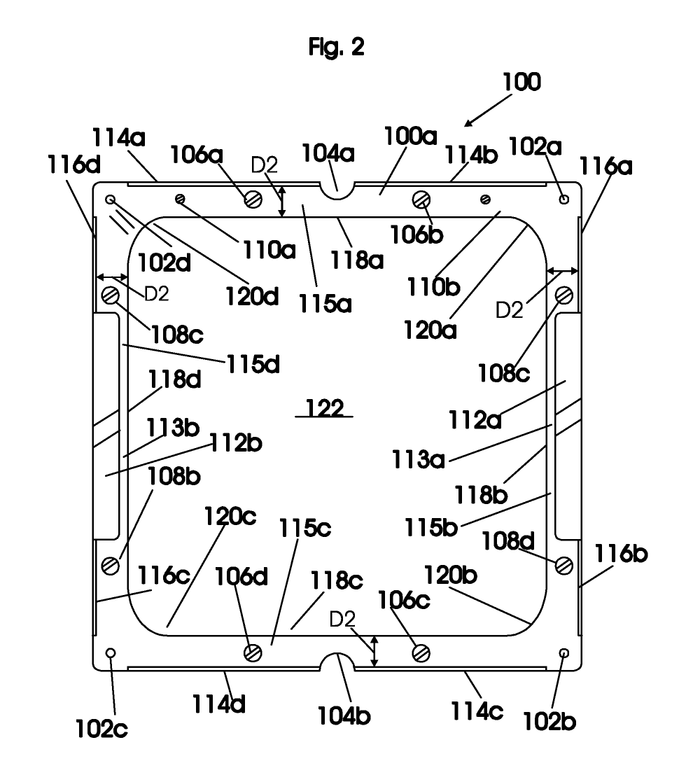

FIG. 2 shows a bottom view of an alignment frame 100 in accordance with an embodiment of the present invention. The alignment frame 100 is a solid metal frame except as will be described. The alignment frame 100 has a bottom surface 100a. The alignment frame 100 includes openings 102a, 102b, 102c, and 102d each of which may be one quarter inch in diameter. The alignment frame 100 has imbedded and fixed therein, magnets 106a, 106b, 106c, 106d, 108a, 108b, 108c, and 108d, each of which may be rare earth magnets and may be disc shaped. The magnets 106a-d and 108a-d typically do not protrude substantially above the bottom surface 100a. The alignment frame 100 also includes registration pins 110a and 110b which are fixed to the frame 100 and which protrude out from the frame 100. The alignment frame 100 has semicircular regions 104a and 104b, each of which may have a diameter of one inch.

The alignment frame 100 includes inner surfaces 118a, 118b, 118c, and 118d. The inner surface 118a is connected to the inner surface 118b through a curved inner surface 120a. The inner surface 118b is connected to the inner surface 118c through a curved inner surface 120b. The inner surface 118c is connected to the inner surface 118d through a curved inner surface 120c. The inner surface 118d is connected to the inner surface 118a through a curved inner surface 120d. The alignment frame 100 also includes indented regions 112a and 112b. Also provided are flanges or protruding sections 114a, 114b, 114c, 114d, 116a, 116b, 116c, and 116d. The alignment frame 100 surrounds a large central opening 122. The flanges 114a, 114b, 114c, and 114d may be elongated and may have a length of five and one half inches and a width of about one eighth of an inch or less. The flanges 116a, 116b, 116c, and 116d may be elongated and may have a length of two and three quarters inches and a width of about one eighth of an inch or less. The distance D2, from the inner surface 118a to the flanges 114a and 114b, as measured perpendicularly to the flanges 114a-b, may be seven eighths of an inch or more. The distance D2, from the inner surface 118b to the flanges 116a-b, from the inner surface 118c to the flanges 114c-d,and from the inner surface 118d to the flanges 116c and 116d, as measured perpendicularly to the flanges 116a-b, 114c-d, and 116c-d, respectively, may be seven eighths of an inch or more. The alignment frame 100 may be described as having four sides or members 115a, 115b, 115c, and 115d.

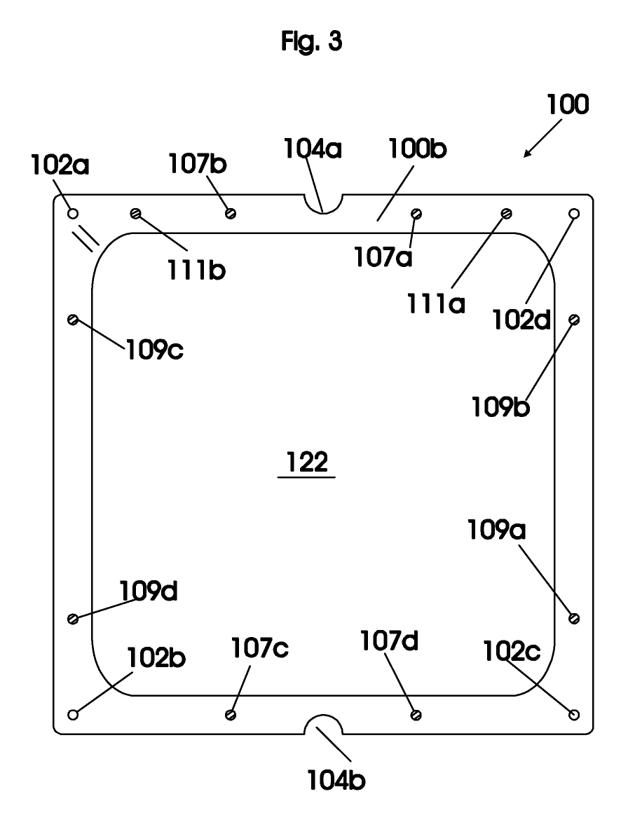

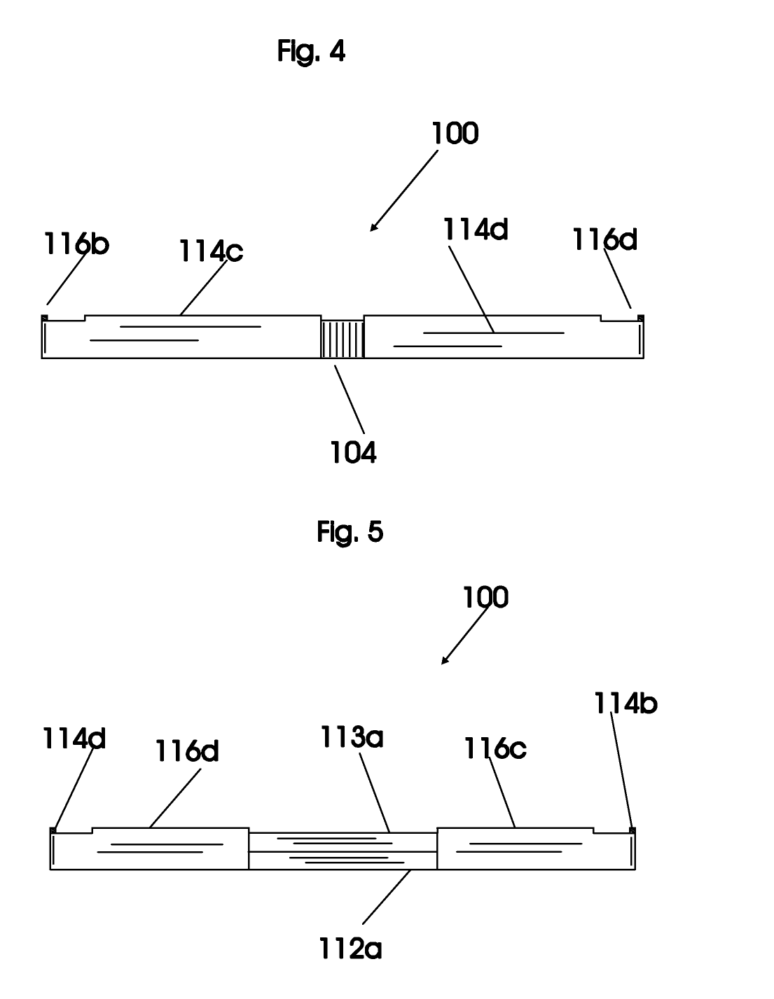

FIGS. 3-5 show top, front, and left side views, respectively, of the alignment frame 100. As shown in FIG. 3, there are indentations 107a, 107b, 107c, 107d, 109a, 109b, 109c, and 109d which correspond to the locations for magnets 106a, 106b, 106c, 106d, 108a, 108b, 108c, and 108d, respectively. There are also indentations 111b and 111a corresponding to the locations for registration pins 110a and 110b, respectively. FIGS. 2 and 5 show indented section 112a and section 113a next to indented section 112a. FIG. 3 also shows top surface 100b of the alignment frame 100.

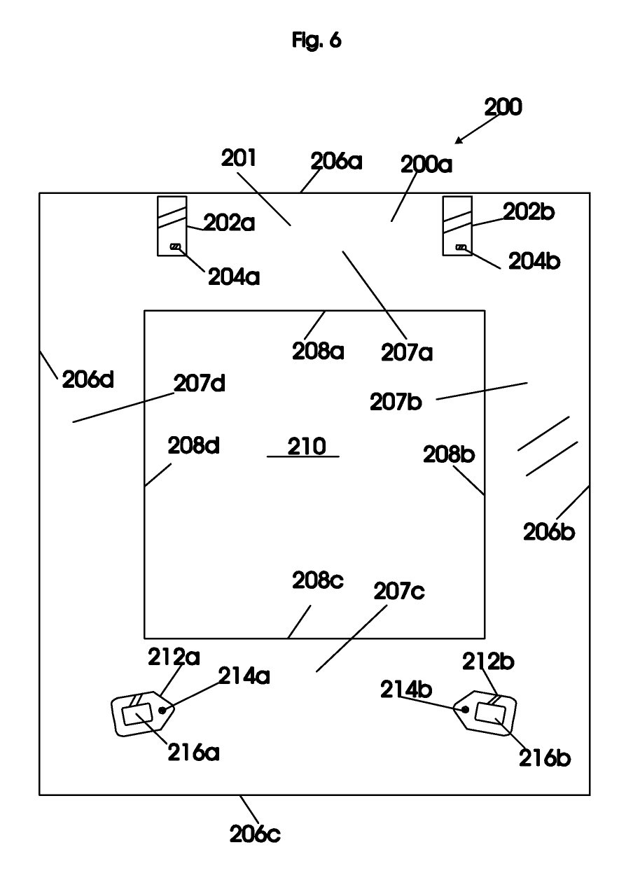

FIG. 6 shows a top view of an alignment device 200 in accordance with an embodiment of the present invention. The alignment device 200 may be comprised of a transparent frame 201 having a top surface 200a. The alignment device 200 may include outer edges 206a, 206b, 206c, and 206d and inner edges 208a, 208b, 208c, and 208d.

The alignment device may be described as having sides or members 207a, 207b, 207c, and 207d. Plates 202a and 202b, which may be made of metal, may be fixed to the frame 201, near the top edge 206a. Artwork registration pins 204a and 204b may be fixed to and may protrude out from plates 202a and 202b, respectively. Plates 212a and 212b, which may be made of metal, are typically fixed to the frame 201 near a bottom edge 206c. There may be openings 216a and 216b in the plates 212a and 212b, respectively. Registration pins 214a and 214b protrude out from plates 212a and 212b. The frame 201 surrounds a large central opening 210. The alignment jig or frame 201 can be made of Plexiglas.

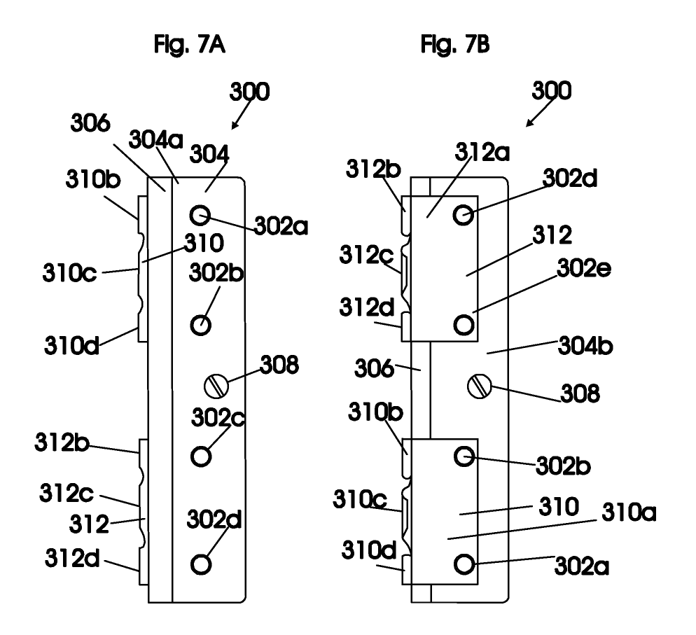

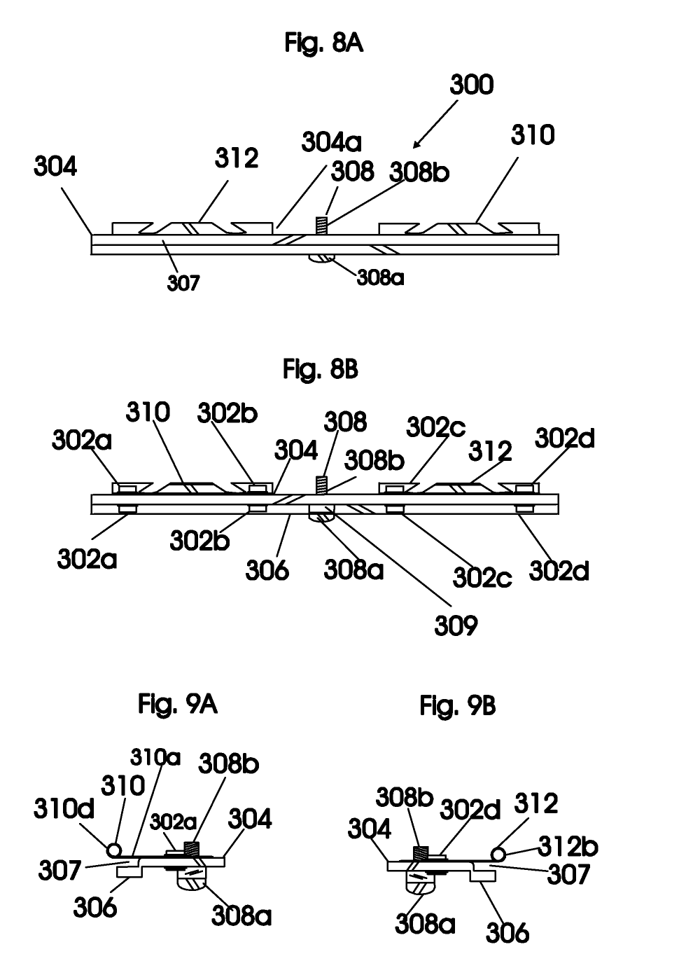

FIGS. 7A-B shows top and bottom views of a quick connect current clip 300 in accordance with an embodiment of the present invention. FIGS. 8A-B show a left and right side views of the quick connect current clip 300. FIGS. 9A-9B show front and rear views of the quick connect current clip 300. The clip 300 includes a plate or plate portion 304 fixed to or integrated with a plate or plate portion 306. The clip 300 also includes attachment devices 310 and 312. Attachment device 310 includes plate 310a, and curled portions 310b, 310c, and 310d. Similarly, attachment device 312 includes plate 312a, and curled portions 312b, 312c, and 312d. The plate 310a is attached and fixed to the plate 304 by pins 302a and 302b. The plate 312a is attached and fixed to the plate 304 by pins 302d and 302e. Screw or bolt 308 has been inserted through an opening in the plate 304 and is fixed to plate 304. The screw or bolt 308 includes head portion 308a and threaded portion 308b as shown in FIGS. 8A and 8B. A spacer 309 is provided between head portion 308a and threaded portion 308b and is shown in FIG. 8B.

FIGS. 8A, 9A, and 9B show a gap 307 which lies between the plates 310a and 312a and the plate 306. The gap 307 allows the clip 300 to be easily attached to the edge of a frame as will be described.

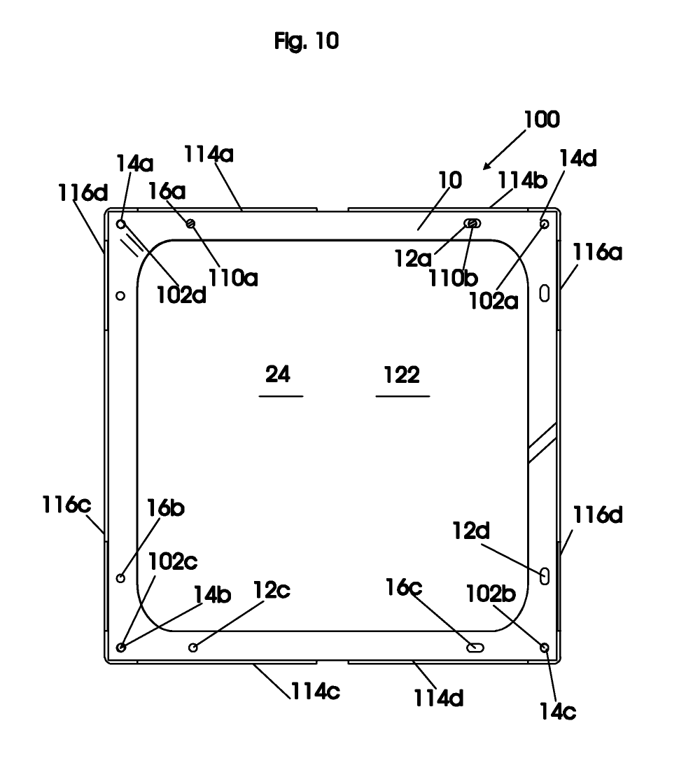

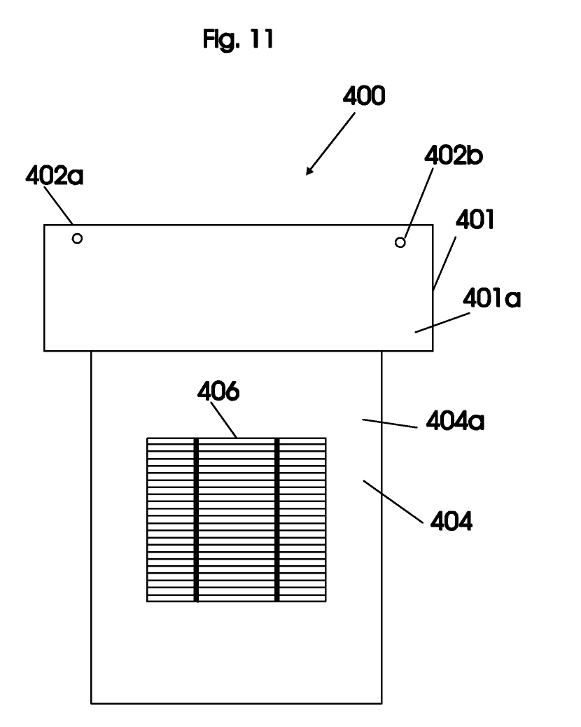

FIG. 10 shows a bottom view of the printing screen frame 10 of FIG. 1 inserted into the alignment frame 100 of FIG. 2. The printing screen frame 10 fits snugly inside the flanges 114a-d and 116a-d of the alignment frame 100. The openings 14a-d of the printing screen frame 10 align with the openings 102a-d of the alignment frame 100. The large openings 24 and 122 align with each other. The registration pins 110a and 110b of the alignment frame 100 are shown inserted through the openings 12a and 16a of the printing screen frame 10.

FIG. 11 shows a top view of a pre-punched substantially transparent sheet 400 having a pattern 406 thereon. The sheet 400 includes portion 401 and portion 404. There are openings 402a and 402b in the portion 401. The portions 401 and 404 have top surfaces 401a and 404a, respectively.

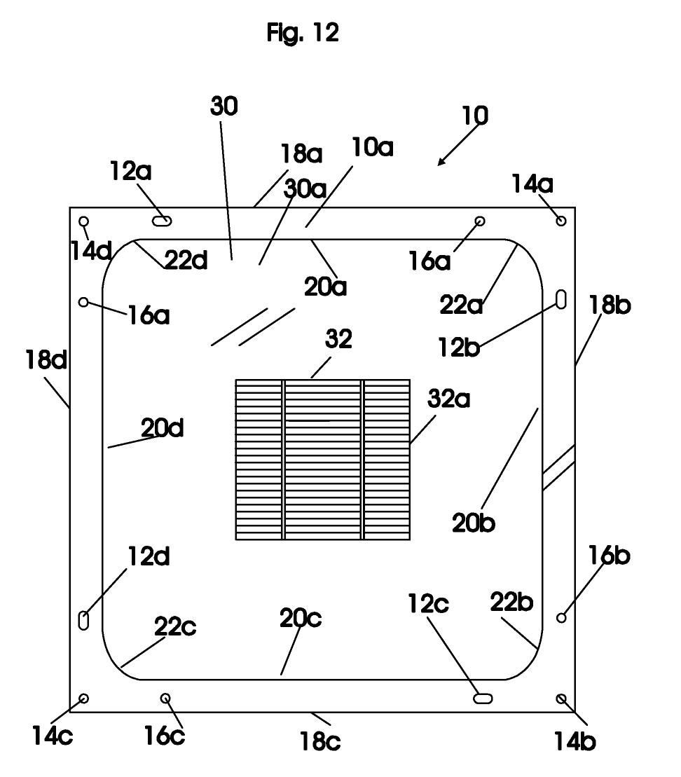

FIG. 12 shows a top view of the printing screen frame 10 with a translucent sheet 30 attached to the printing screen frame 10. The translucent sheet 30 has a top surface 30a. The translucent sheet 30 includes a pattern 32. The pattern 32 has a top side 32a.

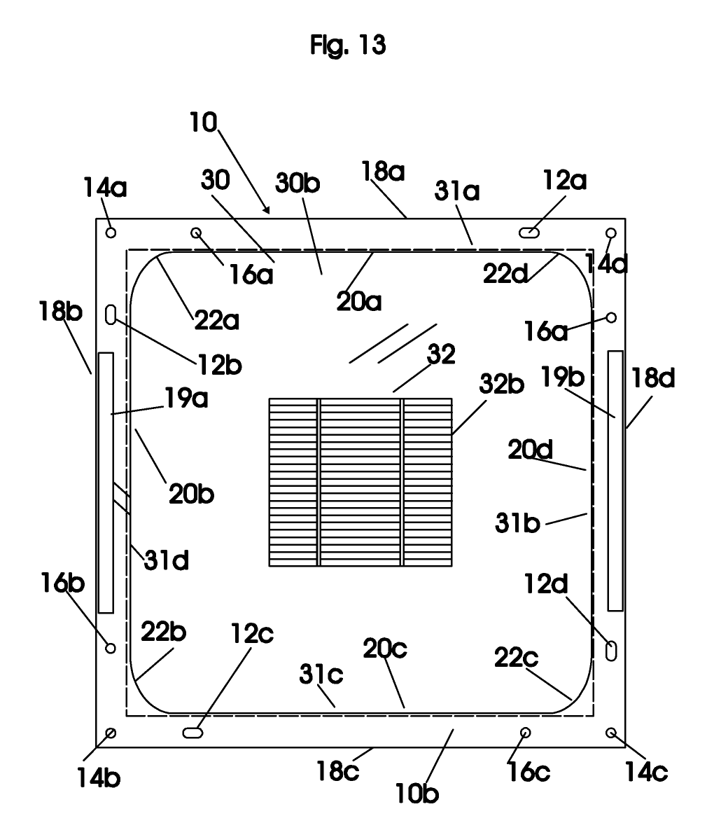

FIG. 13 shows a bottom view of the printing screen frame 10 of FIG. 1 with the translucent sheet 30 attached to the printing screen frame 10. The translucent sheet 30 includes pattern 32 having a bottom side 32b. FIG. 13 shows, by dashed lines, edges 31a, 31b, 31c, and 31d of the translucent sheet 30. Portions of the translucent sheet 30 near the edges 31a-d, are fixed to the frame 10. The printing screen frame 10 has areas 19a and 19b. A clip, such as clip 300, can be attached to each of the areas 19a and 19b, as will be described.

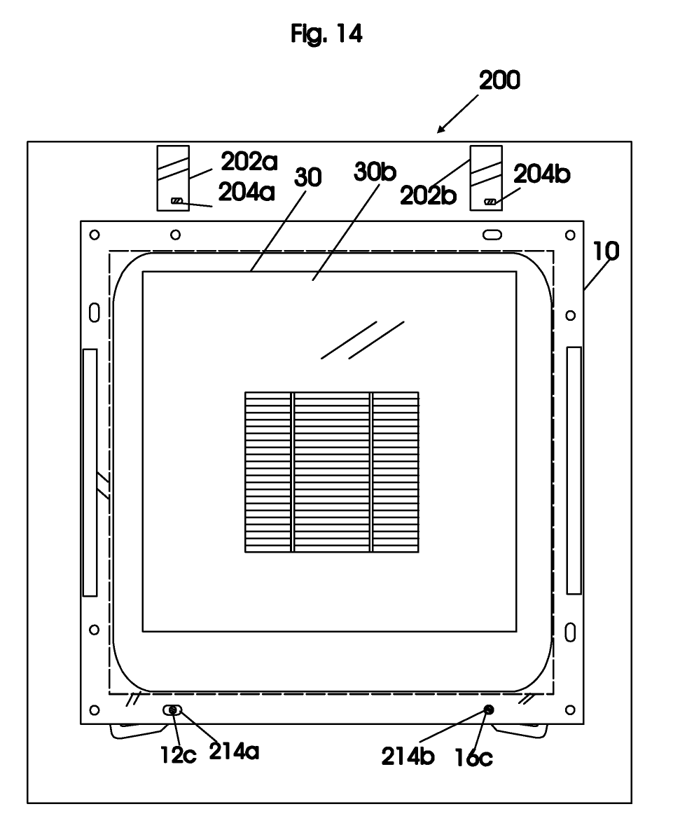

FIG. 14 shows a bottom view of the printing screen frame 10 with the translucent sheet 30 attached to the printing screen frame 10 attached to the alignment device 200 of FIG. 6. In FIG. 14, the registration pins 214a and 214b of the alignment device 200 are inserted through the openings 12c and 16c of the printing screen 10.

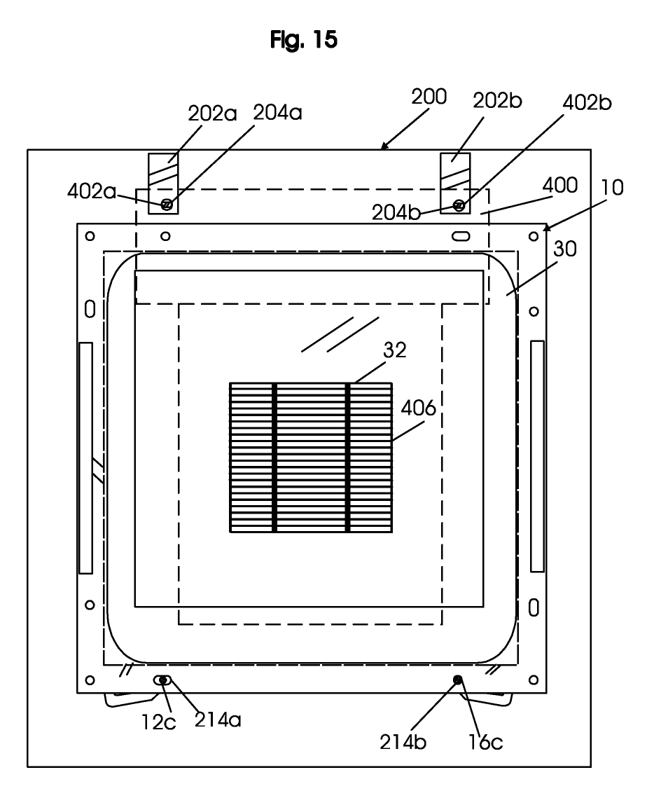

FIG. 15 shows a bottom view of the printing screen frame 10 with the translucent sheet 30 attached to the printing screen frame 10 attached to the alignment device 200, and with the pre-punched substantially transparent sheet 400 attached to the alignment device 200. In FIG. 15, the registration pins 214a and 214b of the alignment device 200 are inserted through the openings 12c and 16c of the printing screen frame 10. This keeps the printing screen frame 10 stationary and in alignment with respect to the alignment device 200. In addition, the registration pins 204a and 204b are shown inserted through the openings 402a and 402b of the sheet 400. This keeps the sheet 400 stationary and in alignment with respect to the alignment device 200 and with respect to the printing screen frame 10. The pattern 406 of the sheet 400 is substantially aligned over the pattern 32.

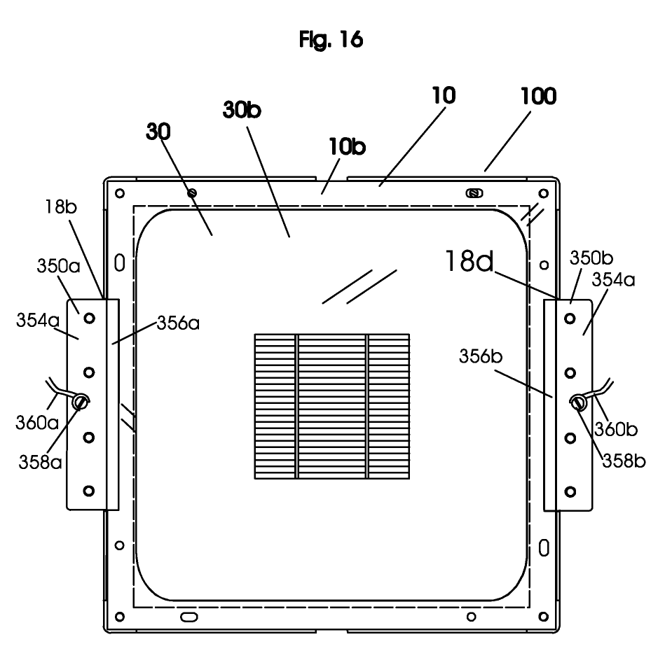

FIG. 16 shows a bottom view of the printing screen frame 10 with attached translucent sheet 30 of FIG. 12 inserted into the alignment frame 100 of FIG. 2, and with two quick connect current clips 350a and 350b attached to the sides of the printing screen frame 10.

The quick connect current clips 350a and 350b may each be identical to clip 300 shown in FIGS. 7A-7B, 8A-8B, and 9A-9B. Each quick connect current clip of clips 350a and 350b , may be attached so that part of an outer edge or side such as part of outer edges or sides 18b and 18d of the screen frame 10, may lie within a gap, substantially identical to gap 307 shown in FIGS. 8A, 9A, and 9B. The clips 350a and 350b are elongated and their longer dimension snugly fits within the indented portions 112b and 112a, respectively, shown in FIG. 2 of the alignment frame 100. Screw or bolts 358a and 358b can be attached to electrical wires 360a and 360b, as shown in FIG. 16, to apply current to the printing screen frame 10 and to the wire mesh or translucent sheet 30. The application of an appropriate amount of electrical current only to the wire mesh or translucent sheet 30 attached to the printing screen frame 10 causes the wire mesh or translucent sheet 30 to be resistively heated to a targeted temperature (generally approximately 70° C.), which in turn will melt a thermally-dependent ink applied to the surface 30a of FIG. 12 or the surface 30b of FIG. 13 of the heated wire cloth of sheet 30 into a printable fluid. At temperatures under the target operating temperature (i.e. under 70 degrees Celsius), the thermally-dependent (“hot melt”) ink remains in solid form on the sheet 30.

One or more embodiments of the present invention, provide a specialized printing screen frame 10 and sheet 30, designed for use in the screen printing process. The printing screen frame 10, which is a printing-plate(s) of a screen printing process, incorporates, or has attached thereto a specifically woven mesh or gauze, or translucent sheet 30 shown in FIG. 13, typically comprised of polyester, nylon, stainless steel and other materials, placed under stress or tension and anchored to a stable frame device or printing screen frame 10 to maintain this tension. An imagable (typically either photographically or mechanically) stencil component in the form of either dry films or liquid coatings or both are applied to the surface 30a of FIG. 12 or the surface 30b of FIG. 13 of the tensioned screen mesh or translucent sheet 30 to control and define the print geometry. Traditionally, the frame part of a screen assembly is a monolithic component, typically comprised of wood or various metals such as aluminum, magnesium or steel, as well as some structural plastic materials. One or more embodiments of the present invention offers benefit over traditional printing screen assemblies in the form of faster alignment of artwork, such as sheet 400 to printing screen frame 10 during prepress, faster and simpler setup alignment of sequential screens to substrate location on printing press, not shown, and can be used interchangeably in both thermally dependent and non-thermally dependent printing applications.

One or more embodiments of the present invention involve at least two main benefits over traditional screen assemblies. The first is that the traditional monolithic screen frame component to which the screen mesh is secured has been replaced by a two-component frame system, incorporating an alignment frame, such as alignment frame 100 of FIG. 2, which mounts and secures directly onto the screen printing machine or station using threaded mounting holes, such as holes 102a-d shown in FIG. 2, and bolts or other locking mechanisms, and a printing screen frame, such as printing screen frame 10, which quickly aligns and secures directly to the alignment frame 100.

The alignment frame 100 shown in FIG. 2, may be metallic, typically aluminum or aluminum alloy (although steel, magnesium or other materials are also usable), and is specifically designed to replicate the outside dimensional profile of any commonly used, industry standard screen frame(s). FIG. 2 depicts an alignment frame design in profile of the Sefar (trademarked) 19A cast aluminum screen frame, but any other existing or future screen frame profile may also be replicated using this concept. Replicating common industry frame profiles allows for direct retrofitting of the new screen design to any existing or future screen printing machines, devices and fixtures that are capable of accepting an existing replicated screen frame profile without need of modification to the printer or alignment frame.

The alignment frame 100 of FIG. 2, may incorporate four ¼—20 threaded thru-holes, 102a-d, one in each corner, and positioned on thirteen inch centers. These will be used to position and securely and semi-permanently affix the alignment frame 100 to a screen printing machine, device or fixture. The top and bottom surfaces 100a and 100b of each alignment frame 100 must be flat and parallel to a designated tolerance that is applicable to the intended printing application. Each alignment frame 100 may or may not have recesses or cut-outs in designated locations, based on the requirements of the intended printing application.

The printing screen frame 10 part of this two component screen design utilizes a stable frame material (such as cold rolled steel) and design to maintain screen tension, dimensional accuracy and stability (as well as other pertinent screen parameters) once the pre-stressed screen mesh or translucent sheet 30, shown in FIG. 13, is secured to the printing screen frame 10. The dimensions of the printing screen frame 10 are specifically designed to allow the completed printing screen apparatus, including sheet 30, to be placed intimately in contact with, and accurately registered and securely anchored to its associated alignment frame, such as 100, while allowing the overall combined thickness and profile of the mated alignment frame 100 and the printing screen apparatus, including printing screen frame 10 and sheet 30, to remain identical to that of the targeted common industry screen frame profile which was replicated in the two component screen design in accordance with an embodiment of the present invention.

The alignment frame, such as alignment frame 100, contains two specifically dimensioned brass alignment pins, such as pins 110a and 110b, protruding out slightly from its bottom surface 100a, as shown in FIG. 2. The design of the printing screen frame 10 used here as an example incorporates a set of specific size round and slotted openings in the printing screen 10 frame, see FIG. 1, which match the brass pins 110a and 110b, located in the corresponding alignment frame 100 in both size and location. This design concept permits the printing screen frame 10, to be quickly, accurately, and repetitively registered and positioned onto the alignment frame 100 by allowing the alignment frame's registration pins 110a and 110b to pass through the registration holes 12a and 16a, respectively, in the printing screen frame 10, as shown in FIG. 10.

The alignment frame 100 also incorporates the use of a specified number of magnets, such as 106a-d and 108a-d shown in FIG. 2 (rare earth disk magnets, electro-magnets or other magnetic materials), each having a specifically designated accumulative maximum pull force. The set of magnets incorporated into the alignment frame 100 will hold and secure the printing screen frame 10 intimately against the bottom surface 100a of the alignment frame 100, when the printing screen frame 10 is aligned to the registration pins 110a and 110b.

Using common pre-press registration techniques, positive RREU (“Right-Reading Emulsion Side-Up) film photo tools can be generated with accurately punched registration holes (or have a pre-punched registration Mylar strip attached) that match commercially available registration pins. This allows the punched and registered artwork to be very accurately aligned to each printing screen frame, such as printing screen frame 10, by using a special alignment fixture or device, such as device 200 shown in FIG. 6. Generally, while some other printing processes need right reading emulsion side down (RRED) photo work, screen-making for screen printing applications typically requires RREU photo tools.

The sheet 400 in FIG. 11 may be comprised of a conventional screen photo tool 404 with pre-punched Mylar 401 attached.

The associated special, dedicated alignment device, such as device 200 in FIG. 6, may have two sets of specific registration pins; one set, such as 214a and 214b, that is identical to the size, position and configuration of two registration holes, of the registration holes 16a-16d and 12a-d in the printing screen frame 10, and another set, such as registration pins 204a and 204b, that is identical to the size, position, and configuration of the registration holes punched into the screen artwork photo tool or sheet 400 and/or pre-punched Mylar strip. For example, the printing screen frame 10, can be positioned so that alignment pins 214a and 214b attached to alignment device 200 match up with holes 12c and 16c, respectively, in the printing screen frame 10 as shown in FIG. 15. The printing screen frame 10 can instead be positioned so that alignment pins 214a and 214b match up with holes 12a and 16a, 12b and 16b, or 12d and 16d.

After registering the printing screen frame 10 to the pins 214a and 214b, the punched photo tool or screen 400 is overlayed (emulsion-side of photo tool facing the printing screen frame 10) on top of the pin-registered printing screen frame 10 and registered to film registration pins 204a and 204b attached to the alignment device 200, by aligning holes 402a and 402b of the screen 400 over registration pins 204a and 204b, respectively, and passing registration pins 204a and 204b through the holes 402a and 402b. The photo tool or screen 400 is typically only registered in position against the surface of the printing screen frame 10 until completion of an application of exposure of a specific dosage of ultraviolet light (screen imaging process). Once the screen exposure is complete the punched photo tool or screen 400 is removed from the printing screen frame 10 and saved.

When the same punched and registered photo-tool, such as sheet 400, is used to image duplicate screens, the orientation of the artwork 400 will be identical on each successive screen. Screen imaging with punched and registered photo tools is common in many prepress operations. However, this only insures that the image is in the identical position on each screen. In one or more embodiments of the present invention a specific alignment frame such as 100, and printing screen frame 10, combination provides the benefit of only having to align the alignment frame 100 (with printing screen frame 10 in place) once per print layer for the same substrate. The substrate is not shown and is typically the object or end product the apparatus of the present invention including printing screen frame 10 and alignment device 100 would be used to print on. Typical objects or end products include ceramic, silicon, paper, metal, plastic, textiles, and glass. Exhausted printing screens frames 10 and sheets 30 can be removed from the printing device or fixture or alignment device 100 without having to remove the registered alignment frame 100. Each successive printing screen frame, similar to 10, and sheet, similar to 30, if imaged using the same punched photo tool, such as 400, can quickly and easily be registered to the alignment frame 100 using the alignment pins, such as pins 110a and 110b, without the need for any additional set-up time to realign the print pattern.

One of the distinct advantages of embodiments of the present invention is that they allow the benefit of quick installation and simultaneous registration of successive printing screens (including frame 10 and sheet 30) to be realized, using any screen printing machine, device or fixture that can accept common industry screen frame profiles. Any limitations and/or restrictions resulting from the need of a dedicated printing machine, and dedicated frame size and profile, to permit the use of pin registration for screens are not typically present when using this new frame concept.

Some printing applications incorporate the use of inks which replace solvent-based and other volatile ink vehicle materials with either waxes, thermoplastic, or other like materials. At room temperature, these inks are solid rather than fluid, but will liquefy when exposed to targeted elevated temperatures (typically in the 50° C. to 70° C. range). Inversely, these special ink formulations will “freeze”, or return to solid form almost immediately when removed from the elevated, operating temperature range. Because of this ink behavior, screen printing processes exist where these inks are heated during the actual printing transfer from screen to substrate. The ink dries or freezes immediately upon leaving the heated screen area after being transferred to the cooler substrate. The advantage to the person printing with these thermally-dependent (or “hot melt”) inks is that no drying cycle, typical with solvent based inks, is needed with hot melt materials. This permits printing of successive colors or layers to occur immediately following the previous hot melt printed color or layer without the need of drying processes, equipment, and the associated additional substrate handling between prints.

The elevated temperature required to fluidize thermally-dependent inks is typically achieved through resistively heating a stainless steel wire mesh screen, such as translucent sheet 30 of FIG. 13, by applying a field of current across the wire mesh or sheet 30 at low-voltage. The specific amount of current/voltage required to heat the surface such as 30a or 30b of the wire screen mesh screen or sheet 30 is dependent on the size (area) and specifications of the wire cloth used.

To prevent the current from flowing into either the printing screen frame 10 or the alignment frame 100 in hot melt versions of this new screen concept, the printing screen 10 frames described herein are “powder-coated” to a coating thickness of 100 microns (0.004′). The powder coating performs the function of electrically insulating the wire screen mesh 30 from the metal printing screen frame(s) 10; therefore the powder coating must not contain any conductive materials or particles. Because of the insulating powder coating on the printing screen frame 10, and similar frames, the wire mesh or translucent sheet 30, or similar sheets can be adhered directly to the powder coated surface without the need of a non-conductive material (such as polyester or nylon mesh) to be incorporated as a link between the wire mesh or translucent sheet 30 and the printing screen frame 10.

A low—resistance method of electrical interconnect is needed to apply current to the tensioned wire mesh, such as 30, which is attached to the powder coated printing screen frame 10. The current flow will be enabled using connections which contact the wire screen mesh, such as sheet 30 only, on opposing sides of the printing screen frame 10. In order to maintain the intended benefit of quick replacement screen insertion and alignment, these connections are also of a quick connect/disconnect design, in the form of a “push-on” clip, such as clip 300, which can use various methods of spring tension to provide both a secure electrical and mechanical contact to the wire screen mesh or sheet 30.

The leads or electrical conductors 360a and 360b from a power supply used to provide the current will be connected directly to the quick connect clips 350a and 350b, respectively, which in turn are placed onto the printing screen frame 10, as shown in FIG. 16. The design of the printing screen frame 10, the printing screen fabrication process and the type of clip 300 used govern the current flow to only pass in and out of the wire screen mesh 30 on opposing sides.

The interconnect positions on all printing screen frames, such as 10, is a small section of exposed wire mesh surface, such as 19a and 19b, shown in FIG. 13, in a designated location and geometry on opposing sides on the frame surface of the printing screen frame 10. These locations are formed by masking the positions of the printing screen frame 10 prior to applying adhesive in the screen stretching stage of the screen fabrication process, or by having special “cutouts” or voids, corresponding to sections 19a and 19b shown in FIG. 13, placed in the printing screen frame 10, and similar frames, when they are fabricated, or by any other appropriate method intended to prevent the screen mesh, such as 30, from being encapsulated by adhesive or other materials during the screen fabrication process.

It is typically necessary to have the screen mesh or sheet 30 bonded to the printing screen frame 10 in a narrow strip (between 0.050′ and 0.100′) between the outside edge at the printing screen frame 10 and the start of the un-encapsulated mesh connection site. This narrow strip of epoxy area, such as 19a and 19b shown in FIG. 13, will securely hold the screen mesh or sheet 30 in place to avoid damage or disturbance during the trimming step of the screen fabrication process, and the actual use of the printing screen 10.

The quick connect current clips 350a and 350b are placed onto the printing screen frame 10 so that the conducting surface of the clips 350a and 350b (such as plates 356a-b and/or plates 354a-b) comes in direct contact with the surface 10b of the un-encapsulated mesh exposed at the mesh connecting site, such as at locations 19a and 19b shown in FIG. 13.

Because the quick connect current clips 350a and 350b carry the applied current coming from a power supply and transfer it to the screen mesh or sheet 30, these clips will also be restively heated along with the screen mesh or sheet 30. Any non-thermally insulated parts of the clips 350a and 350b will be warm or hot to the touch. The printing screen frame 10, by virtue of thermal radiation from the resistively heated clips 350a and 350b and mesh or sheet 30 will also be warm or hot to the touch.

The recesses or “cutouts” 112a and 112b shown in FIG. 2, on the sides of the alignment frame 100 provide clearance for the quick connect current clips 350b and 350a to be positioned without coming in contact with the alignment frame 100. These recesses 112a and 112b may also be used to provide access to the top side 10a of the mounted printing screen frame 10 to gain leverage when separating the printing screen frame 10 from the magnetic hold of the alignment frame 100.

With the appropriate amount of current applied through the quick connect clips 350a and 350b, the printing screen frame surface 10b and/or sheet surface 30b reaches the operating temperature required for most thermally-dependent (hot melt) printing materials. Turning off the current and/or removing the connecting clips 350a and 350b will cause the printing screen frame 10 and sheet 30 to cool and return to ambient temperature.

A basic benefit of the two component frame and screen system of one or more embodiments of the present invention described within is its quick insertion of duplicate or sequential screen-printing screens through the use of alignment pins to register both artwork or sheet, such as 400, and printing screen frame 10 and sheet or mesh 30, in position.

One of the advantages of one or more embodiments of the present invention is that its benefits can be fully realized without having to invest in and use a special dedicated printing machine or fixture, and any screen frame size restrictions which may be associated with such

dedicated equipment. Embodiments of the present invention are intended to provide the quick replacement benefit while remaining versatile enough to be used with most existing and future screen printers and like devices that are able to accept common industry screen frame profiles.

Also, an additional advantage is that the quick insertion/registration benefit is still maintained when printing with thermally dependent inks in a hot-melt mode. The connection clip method of gaining an electromechanical connection specifically to the wire mesh, such as 30 to resistively heat the printing screen frame 10 and sheet 30, is also designed for quick attachment to the printing screen frame 10, either prior to, or after registering the printing screen frame 10 to the alignment frame 100.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

What is claimed is:

1. An apparatus comprising:
a printing screen frame which surrounds a first central opening;
a first sheet attached to the printing screen frame so that the first sheet covers the central opening; and
an alignment device having a second central opening; and
wherein the alignment device has a first means for registering the printing screen frame and the first sheet in a first position and a first orientation, with respect to the alignment device, such that the first central opening of the printing screen frame is substantially aligned with the second central opening of the alignment device.

2. The apparatus of claim 1 wherein
the printing screen frame has a first side, a second side, a third side, and a fourth side, which border the first central opening;
the alignment device has a first side, a second side, a third side, and a fourth side, which border the second central opening;
wherein the first and third sides of the printing screen frame are substantially parallel, the second and fourth sides of the printing screen frame are substantially parallel, and the first and fourth sides of the printing screen frame are substantially perpendicular;
wherein the first and third sides of the alignment device are substantially parallel, the second and fourth sides of the alignment device are substantially parallel, and the first and fourth sides of the alignment device are substantially perpendicular;
the printing screen frame has a first set of openings, each of which passes through the first side of the printing screen frame;
wherein the first means for registering of the alignment device can be inserted into the first set of openings of the printing screen frame in order to register the printing screen frame and the sheet in the first position and the first orientation.

3. The apparatus of claim 2 wherein
the printing screen frame has a second set of openings each of which passes through the second side;
wherein the first means for registering of the alignment device can be inserted into the second set of openings of the printing screen frame in order to register the printing screen frame and the sheet in a second position and a second orientation.

4. The apparatus of claim 1 further comprising
a second sheet having a plurality of openings;
wherein the alignment device includes a second means for registering;
wherein the second means for registering can be inserting through the plurality of openings in order to register the second sheet in a second position and a second orientation with respect to the printing screen frame and with respect to the alignment device;
wherein in the second position and in the second orientation, a central portion of the second sheet is located over the first sheet, over the first central opening of the printing screen frame, and over the second central opening of the alignment device.

5. The apparatus of claim 1 wherein
the first sheet is comprised of a wire mesh.

6. The apparatus of claim 4 wherein
the second sheet is comprised of a photo tool.

7. An apparatus comprising
a printing screen frame which surrounds a first central opening;
a first sheet attached to the printing screen frame so that the first sheet covers the central opening;
an alignment frame which surrounds a second central opening; and
first and second current devices;
wherein the printing screen frame can be inserted into the alignment frame so that the first central opening is aligned with the second central opening;
and wherein the first and second current devices can be attached to first and second opposing ends, respectively, of the printing screen frame, after the printing screen frame has been inserted into the alignment frame, so that current can be applied to the printing screen frame and the first sheet through the first and second current devices.

8. The apparatus of claim 7 wherein
the alignment frame includes a magnetic device for attracting and securing the printing screen frame to the alignment frame.

9. A method comprising the steps of:
attaching a first sheet to a printing screen frame so that the first sheet covers a first central opening of the printing screen frame;
aligning the first central opening of the printing screen frame with a second central opening of an alignment device; and
registering the printing screen frame and the first sheet, in a first position and a first orientation with respect to the alignment device by using a first means for registering located on the alignment device.

10. The method of claim 9 wherein
the printing screen frame has a first side, a second side, a third side, and a fourth side, which border the first central opening;
the alignment device has a first side, a second side, a third side, and a fourth side, which border the second central opening;
wherein the first and third sides of the printing screen frame are substantially parallel, the second and fourth sides of the printing screen frame are substantially parallel, and the first and fourth sides of the printing screen frame are substantially perpendicular;
wherein the first and third sides of the alignment device are substantially parallel, the second and fourth sides of the alignment device are substantially parallel, and the first and fourth sides of the alignment device are substantially perpendicular;
the printing screen frame has a first set of openings, each of which passes through the first side;
wherein the first means for registering of the alignment device is inserted into the first set of openings of the printing screen frame in order to register the printing screen frame and the sheet in the first position and the first orientation.

11. The method of claim 10 wherein
the printing screen frame has a second set of openings each of which passes through the second side;
wherein the first means for registering of the alignment device is inserted into the second set of openings of the printing screen frame in order to register the printing screen frame and the sheet in a second position and a second orientation.

12. The method claim 9 further comprising
aligning a second sheet in a second position and a second orientation with respect to the printing screen frame and with respect to the alignment device;
wherein the second sheet has a plurality of openings;
wherein the alignment device includes a second means for registering;
wherein the second means for registering can be inserting through the plurality of openings in order to register the second sheet in the second position and the second orientation with respect to the printing screen frame and with respect to the alignment device;
wherein in the second position and in the second orientation, a central portion of the second sheet is located over the first sheet, over the first central opening of the printing screen frame, and over the second central opening of the alignment device.

13. The method of claim 9 wherein
the first sheet is comprised of a wire mesh.

14. The method of claim 12 wherein
the second sheet is comprised of a photo tool.

15. A method comprising
attaching a first sheet to a printing screen frame so that the first sheet covers a central opening which is surrounded by the printing screen frame;
inserting the printing screen frame into an alignment frame so that the first central opening of the printing screen frame is aligned with a second central opening of the alignment frame;
attaching first and second current devices onto first and second opposing ends, respectively, of the printing screen frame, after the printing screen frame has been inserted into the alignment frame; and
applying current to the printing screen frame and the first sheet through the first and second current devices.

16. The method of claim 15 further comprising
incorporating a magnetic device into the alignment frame so that the magnetic device can attract and secure the printing screen frame to the alignment frame.
